(19) United States
(12) Patent Application Publication
(10) Pub. No.: US 2014/0369363 A1
(43) Pub. Date: Dec. 18, 2014

(54) Apparatus and Method for Uniquely Enumerating Paths in a Parse Tree

(71) Applicant: Xpliant, Inc., San Jose, CA (US)

(72) Inventors: Guy Hutchison, Santa Clara, CA (US); Tsahi Daniel, Palo Alto, CA (US); Gerald Schmidt, San Jose, CA (US); Sachin Gandhi, San Jose, CA (US)

(73) Assignee: XPLIANT, INC., San Jose, CA (US)

(21) Appl. No.: 13/921,090

(22) Filed: Jun. 18, 2013

(51) Int. Cl. H04L 12/56

(52) U.S. Cl. CPC H04L 45/745
USPC 370/474

(57) ABSTRACT

A method includes constructing a graph characterizing a set of packet headers associated with network traffic. The graph has a unique identifier for each possible combination of packet headers forming a path in the graph. A received packet is associated with a unique identifier in the graph. Characteristics of the received packet are reconstructed based upon the unique identifier.

### FIELD OF THE INVENTION

The present invention relates to switching network data packets. More particularly, the invention relates to switching network data packets by enumerating a set of unique paths in a parse tree.

### BACKGROUND

A variety of techniques exist for switching data packets from an input port to an output port. The first action required for a switching device is to identify the type of packet it has received and locate and extract data fields from the packet. This process is known as parsing a packet.

Parsing involves a formal analysis by a computer of a string of bytes into its constituents, resulting in a parse tree showing their syntactic relation to each other, which may also contain semantic and other information. Thus, a parse tree is an ordered, rooted tree that represents the syntactic structure of a string according to some formal grammar. Parse trees are commonly constructed in terms of the dependency relation of dependency grammars. Parse trees are distinct from abstract syntax trees (also known simply as syntax trees), in that their structure and elements more concretely reflect the syntax of the input language.

Over the last decade computer networking has converged from a wide variety of special-purpose network protocols and specifications such as Asynchronous Transfer Mode (ATM), Token ring, Fiber channel, and Infiniband into the use of Ethernet as a universal physical layer and protocol. In addition to these legacy network protocols oriented at specific features such as call handling, disk access and processor interconnect, new technologies such as virtual machines, distributed computing and cloud computing have also imposed new and varied requirements on Ethernet and Transmission Control Protocol (TCP)/Internet Protocol (IP).

This convergence has lead to an explosion of new protocols, algorithms and tags, which provide the same features as special-purpose network protocols did but, use Ethernet as a transport layer. As the rate of change of new protocols, features and technologies increases there is a corresponding need to deploy these technologies to the field more quickly.

Traditionally new protocols have been provisioned by means of a change to the hardware, specifically a physical change to the Application Specific Integrated Circuit (ASIC), which implements the switching function. This limits the rate of deployment of new protocols to the speed at which these changes can be implemented and fabricated.

In recent years the industry has moved towards the technique of providing programmable parsers as a way to mitigate the impact of changes. Programmable parsers work by means of constructing a tree of possible packet types based on the headers found during parsing. Current parsers keep track of the types of headers they have seen during parsing by setting a bit for each header found, known as a flag.

The use of flags to track the type of headers found is insufficient in some cases, as it does not record the order in which the headers were found. Consequently, existing parsers must use extra flag bits to keep track of order where it is important, and must know the cases in which order information needs to be preserved.

FIG. 1 shows a sample parse tree that detects seven different types of packet headers. All packets arrive as Ethernet packets 101, which may contain optional headers VLAN 102 or VLAN 103, and are then classified as IPv4 104, IPv6 105, or Other 108. IP packets are further classified as TCP 106, UDP 107, or OtherIP 109. In this parse tree a set of 8 flags can uniquely determine the path which was taken.

FIG. 2 shows the parse tree of FIG. 1, but where a GRE header 210 has been added. Because the GRE header can point to an Ethernet header, loops are now possible and a set of flags can no longer determine where a header was found. For example, the sequences:
Eth->VLAN->IPv4->GRE->Eth
Eth->IPv4->GRE->Eth->VLAN
   will now set exactly the same flags, but may need to be handled differently by the forwarding engine which receives the parsed packet data.

In view of the foregoing, it would be desirable to provide an improved technique for resolving paths through a parse tree.

### SUMMARY

A method includes constructing a graph characterizing a set of packet headers associated with network traffic. The graph has a unique identifier for each possible combination of packet headers forming a path in the graph. A received packet is associated with a unique identifier in the graph. Characteristics of the received packet are reconstructed based upon the unique identifier.

A processor includes an associative memory storing a graph characterizing a set of packet headers associated with network traffic. The graph has a unique identifier for each possible combination of packet headers forming a path in the graph. The associative memory matches attributes of a received packet with a unique identifier. An index memory reconstructs characteristics of the received packet based upon the unique identifier.

A method includes forming unique assigned values to arcs in a graph, constraining paths in the graph, forming calculated paths through the graph based upon the assigned values, constructing a path table with the calculated paths and determining whether any of the calculated paths have an identical value, and if so, repeating the forming and constructing operations.

### BRIEF DESCRIPTION OF THE DRAWINGS

The invention is more fully appreciated in connection with the following detailed description taken in conjunction with the accompanying drawings, in which:

FIG. 1 illustrates a parse tree with a loop-free topology.

FIG. 2 illustrates a parse tree which contains loops.

FIG. 3 illustrates the parse tree from FIG. 2 with assigned node and path values in accordance with an embodiment of the invention.

FIG. 4 illustrates processing operations associated with an embodiment of the invention.

FIG. 5A shows header values and path values computed for one example path in accordance with an embodiment of the invention.

FIG. 5B shows header values and path values computed for a second sample path in accordance with an embodiment of the invention.

FIG. 6 illustrates a hardware implementation of a parser using path value calculations in accordance with an embodiment of the invention.

FIG. 7 illustrates processing operations associated with an embodiment of the invention.

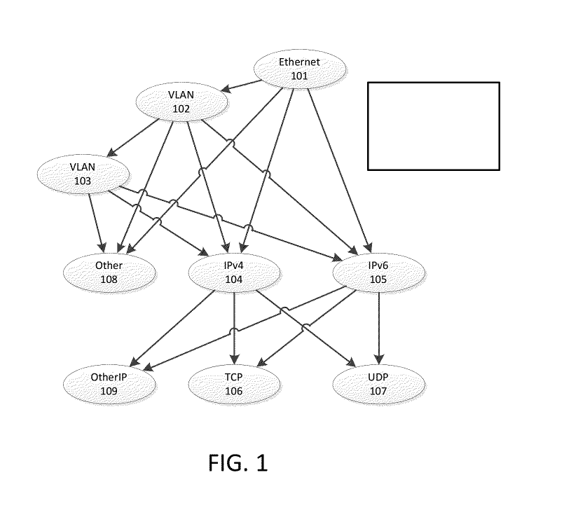

Like reference numerals refer to corresponding parts throughout the several views of the drawings.

### DETAILED DESCRIPTION

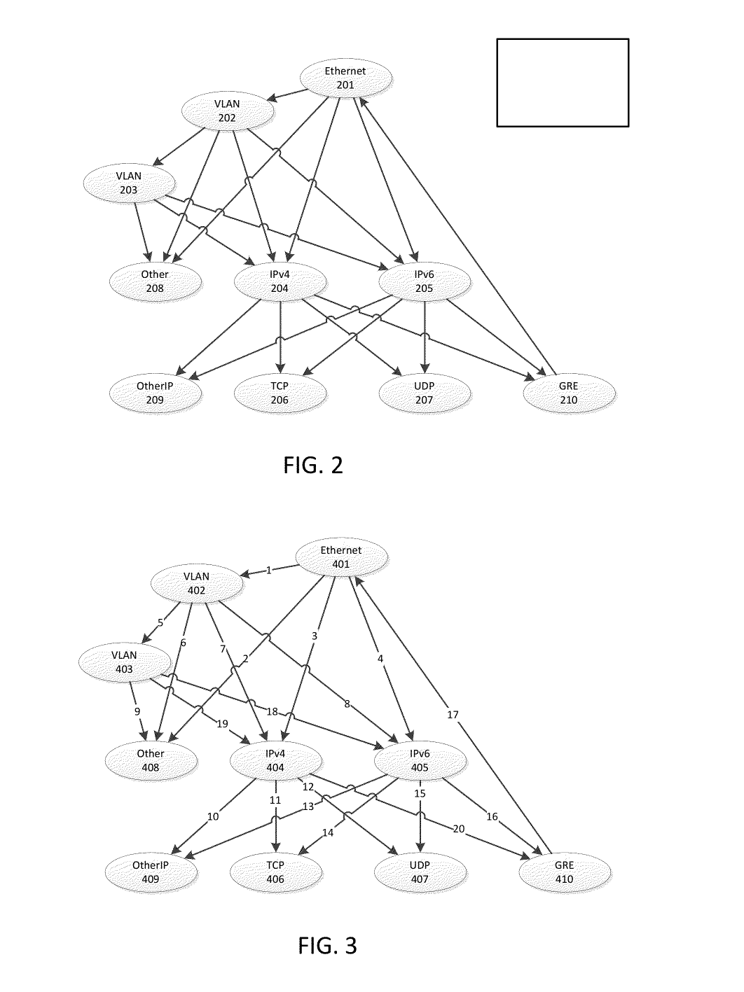

The invention assigns a unique identifier to each possible combination of headers traversed in a parse tree. Advantageously, the unique combination can be efficiently computed in hardware. FIG. 3 illustrates the parse tree from FIG. 2 with assigned node and path values in accordance with an embodiment of the invention.

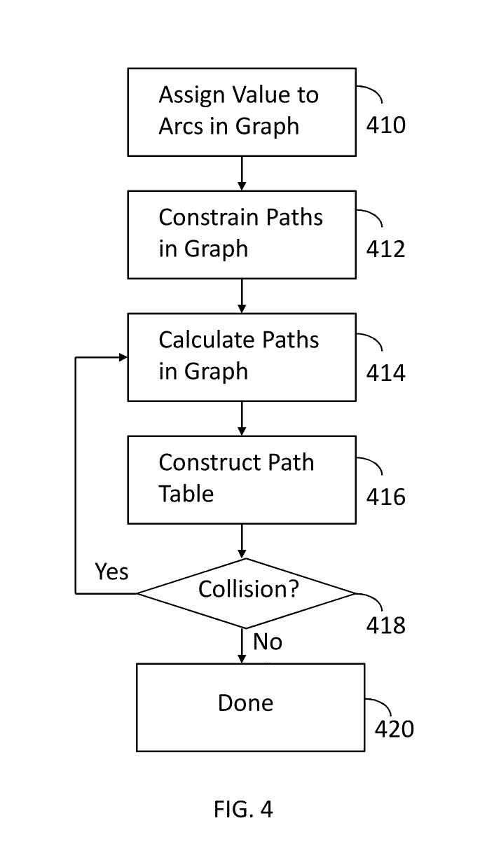

FIG. 4 illustrates processing operations associated with an embodiment of the invention. Initially, values are assigned to arcs in a graph 410. For example, a directed cyclic or acyclic graph may have values assigned to each arc in the graph. The value may be arbitrary, but should be unique for each arc. The values may be assigned sequentially, although a random or semi-random assignment is likely to yield better results. In this context, an arc is a link between two nodes in a graph. A path is a sequence of arcs through the graph.

Constraints are then placed on paths in the graph 412. For example, a directed cyclic graph, as shown in FIG. 2, may be converted into a directed acyclic graph by limiting the number of transitions down cyclic paths, based on the implementer's knowledge of the intended application. For example, the limitation that the arc from GRE 210 to Ethernet 201 can be traversed only once transforms this to an acyclic graph. Once the acyclic graph is created, it may be further reduced based on implementer knowledge by removing transitions to nodes which are uninteresting or which are known not to occur in the implementer's application.

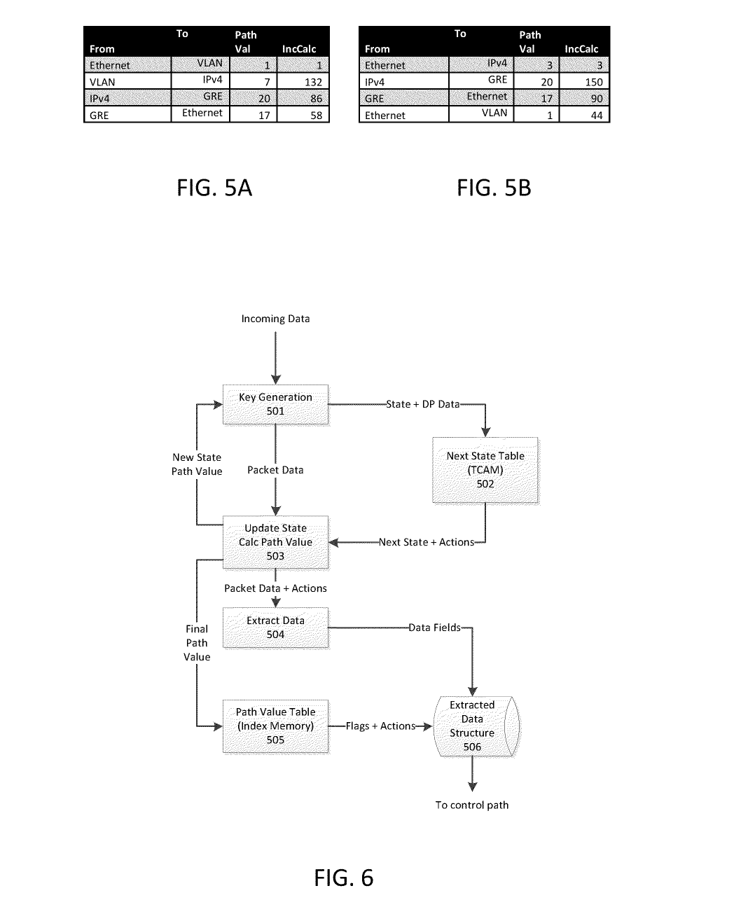

Next, paths are calculated in the graph 414. FIGS. 5A and 5B show an example of the calculation on two such paths, as discussed below. A formula should be chosen either by the implementer or by a random selection which performs the incremental calculation. The formula chosen should be one which is non-commutative, meaning that A+B!=B+A. Most Cyclic Redundancy Check (CRC) functions meet this criterion.

Next, a path table is constructed 416. That is, a table from the results of the possible paths enumerated is constructed. Next, the table is evaluated for common values, termed collisions. No two paths may have the same value, otherwise a collision exists. If a collision does not exist (418—No), then processing is completed 420. Otherwise (418—Yes), processing returns to block 414. If a collision has occurred, then a new set of arc assignments and/or a new formula is applied and the processing of blocks 414-418 is repeated. This cycle is repeated until a collision-free table is created or the algorithm reaches some arbitrary limit and reports failure.

FIG. 3 shows the example parse tree with loops from FIG. 2, but enumerated with a set of unique values on each of the transition arcs. An example of a non-commutative function is shown below in Python pseudocode. For the values shown in FIGS. 5A and 5B, this function produces the output values shown in the IncCalc column of FIGS. 5A and 5B.

# Example of a simple non-commutative function. This
# function repeatedly XORs the value 0x83 into its
# current state based on whether the lower bit of
# cstate is 1. It then shifts the value of cstate by
# one bit. The shift gives the function its
# non-commutative property.
# This is a simplified version of an 8-bit CRC function
# using the polynomial x\hat{ }7 + x + 1
def function8 (val, cstate):

if (cstate & 1):

cstate = (cstate >> 1) \hat{ } 0x83

else:

cstate = (cstate >> 1)

cstate = (cstate \hat{ } val) & 0xFF
return cstate

def twoseq( ):

path_fig5a = [1,7,20,17] # arc sequences from Fig 5A
path_fig3b = [3,20,17,1] # arc sequences from Fig 5B
cstate = 0
for arcValue in path_fig5a:

cstate = function8(arcValue,cstate)
print “path_fig3a: %4d %4d” % (arcValue,cstate)

cstate = 0
for arcValue in path_fig5b:

cstate = function8(arcValue,cstate)
print “path_fig3b: %4d %4d” % (arcValue,cstate)

Using the formula described above by function8, we show that path hash calculations for two packets which contain identical header types but arranged in a different order result in two different path hash calculations.

On the parse path for the first packet, using the enumerated path values shown in FIG. 3, the resulting sequence of path values becomes 1, 7, 20 and 17, as shown in FIG. 5A. The twoseq( ) function above uses the formula8( ) function to compute the incremental path hash calculations of 1, 132, 86 and 58, as shown in FIG. 5A. We use the last incremental path hash calculation of 58 as the final path hash value for the first packet.

Each path hash computation begins in the same way, by initializing a state variable cstate to a constant value (in this case zero). For each arc that is traversed by the parser, a new incremental state value cstate is computed by calling formula8( ) with the value of the cstate as well as the arc value for each arc. The pseudocode above supplies the value of cstate and arcValue as it computes each new cstate value. In one embodiment, only the final value would be retained and passed on for subsequent processing. In the foregoing example, the formula8( ) calculation yields incremental path hash calculations of 1, 132, 86, 58. Only the last incremental path hash calculation of 58 may be passed as the final path hash value for the first packet.

On the parse path for the second packet, the resulting sequence of path values is 3, 20, 17, 1, resulting in incremental path hash values of 3, 150, 90, 44, where 44 is the final path hash used for subsequent processing. These values are shown in FIG. 5B.

For a correctly chosen function and set of arc values, every valid path through a parse tree will result in a unique identifier, which can then later be used to reconstruct both the path which was taken and which headers were present. Storing this single value is significantly more compact than storing all intermediate values.

FIG. 6 shows the hardware implementation of a parser using path value calculations. By way of example, the functional blocks of FIG. 6 may be implemented in an ASIC. Data arrives into the parser in chunks which are typically less than a full packet. The parser decides which decision point it should look at in the packet, expressed as an offset of a number of bytes from the beginning of the packet. The data at this offset is extracted by the Key Generation 501 unit, and is sent along with the current state to the Next State Table 502. The Next State Table is typically implemented as a Ternary Content Addressable Memory (TCAM) or other associative data structure. The TCAM has an entry for each arc in a parse tree. A match in the TCAM provides the next state and/or an action to be taken. The actions may specify data to be recorded in the Extracted Data Structure 506, such as fields to be extracted from the packet, offsets of fields from the packet, or flags to indicate that particular fields were present or absent. Actions may also specify whether the parser should continue to parse the packet or whether sufficient information has been discovered and parsing can terminate.

The results of the Next State Table 502 are used to update the current state and perform the incremental Path Value calculation in block 503. In the prior art, flags are set at this point, but that operation can be omitted because each path has a unique identity. Therefore, that identity can be used to specify path components and order. If the actions indicate that parsing is complete, the final path value is forwarded to the Path Value Table 505. Otherwise the current State and Path Values are sent back to Key Generation 501 where additional searches are performed until parsing is complete.

Packet Data from Incoming Data and Actions from the Next State Table 502 are used to extract the data fields of interest from the packet, which are then sent to the Extracted Data Structure 506. At the end of parsing, the results of the Path Value Table 505 are added to this structure, which is then sent to the control path which will determine how the packet will be forwarded.

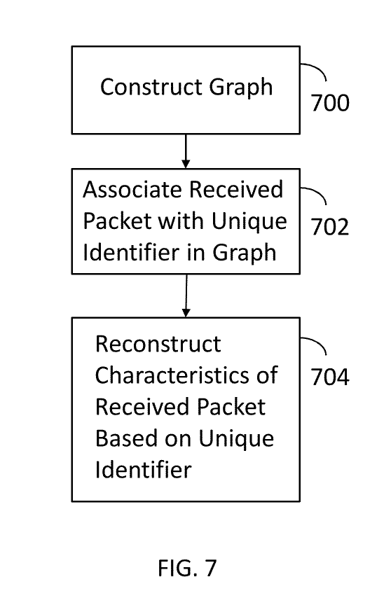

FIG. 7 illustrates processing operations associated with an embodiment of the invention. Initially, a graph is constructed 700. For example, the operations of FIG. 4 may be used to construct the graph. Next, a received packet is associated with a unique identifier in the graph 702. The processor of FIG. 6 may be used to implement this operation. In particular, the next state table 502 may be used to incrementally traverse arcs of path. This ultimately produces a final path value, which is applied to the index memory 505. Finally, characteristics of the received packed are reconstructed based on the unique identifier. This operation may also be implemented with the processor of FIG. 6. In particular, an extracted data structure 506 is produced for the traversed path. The extracted data structure uniquely identifies the traversed path and therefore characterizes the packet headers associated with the received packet. The extracted data structure may also have associated flags and actions.

Some advanced parsers use a multiple simultaneous match parser (sometimes referred to as Kangaroo parsing), in which the Next State Table 502 is capable of matching multiple arcs in the parse tree during a single lookup. In the case of FIG. 3, a Kangaroo parser capable of performing 3 matches per lookup could traverse from Ethernet 401 to IPv4 404 via nodes VLAN 402 and VLAN 403. Because the same single lookup could potentially traverse directly from Ethernet 401 to IPv4 404, and the goal of a Path Value is to have a different Path Value for each path taken, the Path Value formula must take this into account for this type of parser.

In a Kangaroo-type parser, the Path Value formula incorporates some information for each possible path taken, rather than simply the node identifier. FIG. 3 shows the parse tree from FIG. 2, but where each arc in the design has been enumerated with a unique value. If multiple arcs are traversed in a single lookup, the Path Value calculation determines which arcs were traversed and computes a new Path Value based on the enumerated arc values. In this case the Path Value will incorporate up to three values per lookup.

There are other values which could be used to compute the Path Value and are still likely to produce a unique enumeration for each path. For example, the Ethernet type values used to determine the next state, as well as the key values which are sent to the Next State Lookup, are both viable candidates, as is a combination of data from the packet used to determine the state along with internal state such as node numbers or arc numbers.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A method, comprising:
constructing a graph characterizing a set of packet headers associated with network traffic, wherein the graph has a unique identifier for each possible combination of packet headers forming a path in the graph;
associating a received packet with a unique identifier in the graph; and
reconstructing characteristics of the received packet based upon the unique identifier.

2. The method of claim 1 wherein the unique identifier is based upon a non-commutative function.

3. The method of claim 2 wherein the non-commutative function is a Cyclic Redundancy Check function.

4. The method of claim 1 wherein the characteristics specify the headers present in a traversed path.

5. The method of claim 1 wherein the characteristics have an associated set of flags.

6. The method of claim 1 wherein the characteristics have an associated set of actions.

7. The method of claim 1 further comprising loading the graph into an associative memory as a path table.

8. The method of claim 1 further comprising operating the associative memory as a multiple simultaneous match parser capable of matching multiple paths in a single lookup.

9. A processor, comprising:
an associative memory storing a graph characterizing a set of packet headers associated with network traffic, wherein the graph has a unique identifier for each possible combination of packet headers forming a path in the graph, wherein the associative memory matches attributes of a received packet with a unique identifier; and
an index memory to reconstruct characteristics of the received packet based upon the unique identifier.

10. The processor of claim 9 wherein the associative memory is a Ternary Content Addressable Memory.

11. The processor of claim 9 wherein the associative memory operates as a multiple simultaneous match parser capable of matching multiple paths in a single lookup.

12. The processor of claim 9 wherein the unique identifier is based upon a non-commutative function.

13. The processor of claim 12 wherein the non-commutative function is a Cyclic Redundancy Check function.

14. The processor of claim 9 wherein the characteristics specify the headers present in a traversed path.

15. The processor of claim 9 wherein the characteristics have an associated set of flags.

16. The processor of claim 9 wherein the characteristics have an associated set of actions.

17. A method, comprising;
forming unique assigned values to arcs in a graph;
constraining paths in the graph;
forming calculated paths through the graph based upon the assigned values;
constructing a path table with the calculated paths; and
determining whether any of the calculated paths have an identical value, and if so, repeating the forming and constructing operations.

18. The method of claim 17 wherein constraining paths includes limiting the number of transitions through cyclic paths in the graph.

19. The method of claim 17 wherein constraining paths includes selectively eliminating paths in the graph.

20. The method of claim 17 wherein the unique assigned values are based upon a non-commutative function.
